(19) United States
(12) Patent Application Publication
(10) Pub. No.: US 2025/0178771 A1
(43) Pub. Date: Jun. 5, 2025

(54) REUSABLE PLASTIC CONTAINER AND METHOD FOR REPROCESSING

(71) Applicant: Greiner Packaging International GmbH, Kremsmuenster (AT)

(72) Inventors: Markus LEHNER, Micheldorf (AT); Guenter AUSSERWOEGER, Gallneukirchen (AT); Martin WEINGARTMAIR, Prambachkirchen (AT)

(73) Assignee: Greiner Packaging International GmbH, Kremsmuenster (AT)

(21) Appl. No.: 19/043,649

(22) Filed: Feb. 3, 2025

Related U.S. Application Data
(62) Division of application No. 18/377,411, filed on Oct. 6, 2023.

(30) Foreign Application Priority Data
Oct. 10, 2022 (AT) A 50783/2022

(51) Int. Cl. B65D 1/26; B65B 3/04; B65B 7/28; B65B 55/24; B65D 25/20; B65D 25/36; B65D 77/20

(52) U.S. Cl. CPC B65D 1/265; B65B 3/04; B65B 7/2842; B65B 55/24; B65D 25/205; B65D 25/36; B65D 77/2024

(57) ABSTRACT

A method for reprocessing a cup-shaped reusable plastic container includes providing a cup-shaped reusable plastic container with a container jacket having an open end and a closed end with a base, wherein a longitudinal axis of the cup-shaped reusable plastic container extends between the open end and the closed end. The open end has a sealing edge with a sealing surface connected to a first sealing foil. The first sealing foil is removed from the sealing surface and a first cleaning of the cup-shaped reusable plastic container is performed to remove content residues. The sealing surface is processed to restore a connectability of the sealing surface of the sealing edge with a sealing foil and the reusable cup-shaped plastic container is refilled with a product. The sealing surface is reconnected to a further sealing foil.

### CROSS REFERENCE TO RELATED APPLICATIONS

This application is a divisional of and Applicant claims priority under 35 U.S.C. §§ 120 and 121 of U.S. patent application Ser. No. 18/377,411 filed on Oct. 6, 2023 which claims priority under U.S.C. § 119 of Austrian Application No. A 50783/2022 filed Oct. 10, 2022, the disclosures of each of which are hereby incorporated by reference.

### BACKGROUND OF THE INVENTION

### 1. Field of the Invention

The invention relates to a cup-shaped reusable plastic container, and to a method for reprocessing a cup-shaped reusable plastic container.

### 2. Description of the Related Art

Due to increasingly stringent environmental requirements of products and product packaging, it is becoming increasingly important to enable reuse and thus a circular lifecycle. When recycling, it ought to be possible to process products and product packaging for repeat or multiple use without or largely without quality losses. It is hereby further necessary that products and product packaging can be rendered reusable without disproportionate cleaning and reprocessing effort. Products and product packaging destined for recycling ought to therefore be or be rendered sustainably producible and reusable in a sustainable and thus resource-efficient way.

### SUMMARY OF THE INVENTION

The problem to be solved by the present invention was to overcome the disadvantages of the prior art and provide a cup-shaped reusable plastic container that can be reused in a sustainable way.

This problem is solved by an apparatus and method according to the claims.

The invention relates to a cup-shaped reusable plastic container, said reusable plastic container preferably comprising a food-safe plastic material, and said reusable plastic container comprising a container jacket, said container jacket having an open end and a closed end with a base, wherein a longitudinal axis extends between the open end and the closed end, and wherein the open end has a sealing edge with a sealing surface, said sealing surface being configured such that the sealing surface is connectable with a first sealing foil, i.e. can be sealed thereupon.

It is thereby provided that the container jacket has a wall thickness, said wall thickness being from 0.5 mm to 4.0 mm, and that the sealing edge has a sealing edge thickness, said sealing edge thickness extending in an axial direction to the longitudinal axis, and said sealing edge being from 0.8 mm to 4.0 mm, and that the sealing edge is configured such that the sealing surface is connectable with a further sealing foil after removal of the first sealing foil from the sealing surface of the sealing edge, and after cleaning of the reusable plastic container.

The container jacket preferably has a wall thickness of 1.0 mm to 2.5 mm. In a particularly preferred embodiment, the wall thickness is 1.3 mm to 2.0 mm, wherein a wall thickness of 1.5 mm has proven to be particularly advantageous. This is contrary to conventional disposable plastic containers which usually have a wall thickness of 0.3 mm to 1.0 mm.

The container jacket preferably has a sealing edge thickness of 1.0 mm to 2.5 mm. In a particularly preferred embodiment, the sealing edge thickness is 1.3 mm to 2.0 mm, wherein a sealing edge thickness of 1.5 mm has proven to be particularly advantageous. This is contrary to conventional disposable plastic containers which usually have a sealing edge thickness of 0.5 mm to 0.8 mm.

The cup-shaped reusable plastic container according to the invention, in particular the disclosed wall thickness of the container jacket, provides the surprising advantage that it is sufficiently stable and durable to be recycled repeatedly, whilst also being sufficiently lightweight to be convenient and easy to handle. This is true both with respect to goods transport, where the weight of packaging material ought to be kept as low as possible for sustainability reasons, as well as with respect to handling by a user for whom a high packaging weight is also disadvantageous. The cup-shaped reusable plastic container according to the invention, in particular the disclosed sealing edge thickness of the sealing edge, as well as the configuration of the sealing surface such that it can be reused after cleaning, provides the surprising advantage that it can be repeatedly processed and resealed without or largely without having to accept losses in the quality of the packaging or the sealability. In particular in combination with the features according to the invention, it was surprisingly found that a reusable container is provided which offers a user the same or approximately the same advantages with respect to use as they would be familiar with from a conventional, that is to say disposable, plastic container, and which nevertheless is reusable or can be rendered reusable particularly easily. Accordingly, the reusable container fulfils both the requirements made by a user of packaging containers as well as the requirements made by industry of a reusable container.

The term sealing foil therefore covers all types of sealing foils known in the art. Aluminium foils, plastic foils, and hybrid and composite foils are known, for instance. The sealing foils can have different properties depending on the intended application as a cover or seal. By way of example and by no means as an exhaustive list, adhesive processes and welding processes are possible sealing methods. Sealing foils as known in the art are connected with a sealing surface of a sealing edge such that they seal a container or pot, wherein the connection between sealing foil and sealing surface is detachable in that the sealing foil can be peeled off the sealing surface. This is usually done with the aid of a peeling tab, also formed by the foil. The user thereby gains access to a product contained in the container. The original, i.e. first applied sealing foil and the further sealing foil(s) can thereby be of the same or different types. It is therefore possible that a method for applying sealing foils always comprises the same methods, or that different methods of application can be performed.

Cleaning the reusable plastic container can be performed as a method step during a reprocessing method. The connection and thus the sealing of the container with a further sealing foil after cleaning can occur in particular after use, cleaning and refilling of the reusable plastic container.

It is also possible that the container, in particular the inner surface of the container and/or the sealing surface, has a coating, in particular a SiOx coating, said coating giving the inner surface or sealing surface a particularly smooth finish. Such a further embodiment has the advantage that thorough, hygienic cleaning is also improved in case of multiple use and cleaning. A coated sealing edge has the advantage that any adherent residues of a previous sealing foil or adhesive can be removed effectively.

Furthermore, it can be expedient for the container jacket to comprise a conical section, said conical section extending from the closed end to the open end, and for the container jacket to have a cylindrical section, said cylindrical section extending from the open end to the closed end, wherein when viewed in radial direction to the longitudinal axis, i.e. viewed at 90° to the longitudinal axis, a circular cross section of the cylindrical section is greater than a maximum circular cross section of the conical section. The conical section is thereby, as is generally known from cup-shaped containers, configured such that the diameter of the conical section is smaller at the base and becomes continually broader as it moves upwards, that is to say towards the open end of the container.

This provides the advantage that a cup configured in such a way can be held particularly well by a user because the cylindrical upper section with its larger circular cross section practically serves as a limit for the user's hand or fingers. Furthermore, several containers configured in such a way can be inserted and stacked into one another in a space-saving manner.

Moreover, it can be provided for a conical transition section to be configured between the conical section and the cylindrical section, wherein a first angle between the longitudinal axis and the conical section is smaller than a second angle between the longitudinal axis and the conical transition section. It is also possible for the transition section to be at least substantially conical, and for there to be a chamfer, fillet or inward-facing rounding towards the longitudinal axis, each extending in the circumferential direction, in the transition area between the conical section and the transition section, as well as in the transition area between the transition section and the cylindrical section. When viewing the container in a radial direction to the longitudinal axis, i.e. 90° to the longitudinal axis, a minimum circular cross section of the transition section corresponds to the maximum circular cross section of the conical section, and a maximum circular cross section of the transition section corresponds to the circular cross section of the cylindrical section.

That provides the advantage that a second angle that is greater than a first angle creates a transition section which enables a diameter enlargement from the conical to the cylindrical section in a technically simple and optically attractive manner.

Furthermore, it can be provided for the container jacket to be configured with recesses, said recesses extending substantially parallel to the longitudinal axis across the cylindrical section. If the recesses also additionally extend across the transition section or part of the transition section, and if the transition section is conical, the recesses in the transition section area are then aligned parallel to the jacket of the transition section instead of parallel to the longitudinal axis. The recesses can thereby be groove-like, for example, and when viewed in axial direction, that is to say along the longitudinal axis, can have a semi-circular or circular ring segment cross section. The recesses can thereby have identical or different shapes and have the same or different lengths or longitudinal extensions.

That provides the advantage that during cleaning of the container, which can be performed in particular for reprocessing with a view to recycling, the container dries comparatively quickly and without or at least largely without the use of additional thermal or convection energy. In particular, providing for recesses in the cylindrical section and where appropriate also in the transition section can enable good ventilation.

An embodiment according to which it can be provided for the recesses to have a depth in the radial direction to the longitudinal axis, said depth being 1% to 70% of the wall thickness of the container jacket, is advantageous.

That provides the advantage that during cleaning of the container, which can be performed in particular for reprocessing with a view to recycling, the container dries comparatively quickly and without or at least largely without the use of additional thermal or convection energy.

According to a further embodiment, it is possible for a center of mass of the reusable plastic container to be outside the longitudinal axis. This can be achieved through differences in the material thickness, for instance. It is, however, also conceivable that this is achieved with different materials with different densities. Containers are usually configured symmetrically and have a center of gravity on the longitudinal axis. An embodiment according to which the center of gravity is outside the longitudinal axis provides the advantage that when transported to a reverse vending machine for reusable containers or in a cleaning facility, such a container, when lying on its side, i.e. not placed upright on its base, but rather transported on its jacket surface, is not or is only slightly or relatively slightly inclined to roll. Good transportability or conveyability can thus generally be enabled, and in particular detection/shape recognition in a reverse vending machine can be facilitated and cleaning in a cleaning facility simplified.

Furthermore, it can be expedient for the center of mass of the reusable plastic container to be in a half of the container height facing the closed end when viewed along the container height, in particular in a third of the container height facing the closed end. In other words, that means that the center of mass of the container is less far away from the container base than from the upper open end of the container. This is contrary to known cup-shaped containers in which the center of mass is closer to the upper open container than to the container base. The term container height denotes the maximum axial longitudinal extension of the container.

Preferably, the center of mass of the container is within the area or volume covered by the container jacket.

This provides the advantage that when transported to a reverse vending machine for reusable containers or in a cleaning facility, such a container, when lying on its side, i.e. not placed upright on its base, but rather transported on its jacket surface, is not or is only slightly or relatively slightly inclined to roll. Good transportability or conveyability can thus generally be enabled, and in particular detection/shape recognition in a reverse vending machine can be facilitated and cleaning in a cleaning facility simplified.

Furthermore, it can be provided for the base to be circular and have different base thicknesses along its diameter, said base thicknesses being between 0.5 mm and 4.0 mm. When viewing the base in axial cross section, the base can have a continual or gradually increasing base thickness gradient from the center point of the base to the outer diameter of the base. It is, however, also conceivable for the base to have partial bulges, for instance. The transition area from the base to the container jacket can thus be configured with a bulge, for example, such as a thickened fillet.

The base thickness is preferably the same as the wall thickness. It can also be advantageous for the base thickness to be greater or at least slightly greater than the wall thickness. The base preferably has a thickness of 1.0 mm to 2.5 mm. In a particularly preferred embodiment, the base thickness is 1.3 mm to 2.0 mm, wherein in particular a base thickness of 1.5 mm has proven to be advantageous.

This provides the advantage that when transported to a reverse vending machine for reusable containers or in a cleaning facility, such a container, when lying on its side, i.e. not placed upright on its base, but rather transported on its jacket surface, is not or is only slightly or relatively slightly inclined to roll. Good transportability or conveyability can thus generally be enabled, and in particular detection/shape recognition in a reverse vending machine can be facilitated and cleaning in a cleaning facility simplified.

Furthermore, it can be provided for the wall thickness of the container jacket to vary. For example, one half of the container jacket, when viewed in axial cross section, can be configured with a greater wall thickness. It is also possible for the container jacket to have a homogeneous wall thickness and for there to be one or several partial bulges with greater wall thicknesses configured in the container jacket.

This provides the advantage that when transported to a reverse vending machine for reusable containers or in a cleaning facility, such a container, when lying on its side, i.e. not placed upright on its base, but rather transported on its jacket surface, is not or is only slightly or relatively slightly inclined to roll. Good transportability or conveyability can thus generally be enabled, and in particular detection/shape recognition in a reverse vending machine can be facilitated and cleaning in a cleaning facility simplified.

According to a particular embodiment, it is possible for a detectable element to be applied to or incorporated into the base and/or the container jacket.

A variety of detectable elements are known in the art. It is at the discretion of the skilled person to select one or more of these known elements depending on which detector is needed or in which process detection is required/should occur. Detection in a reverse vending machine can be simplified by providing for a detectable element, such as for calculating a deposit value. It is also conceivable that the detectable element serves to detect container types and simplify warehousing logistics in a recycling plant. The detectable element can be an element with a magnetically readable coding. It is also conceivable that the detectable element is an NFC chip, an RFID chip, or a label comprising an NFC chip or an RFID chip. It is also conceivable that the detectable element is a watermark, a barcode, or a QR code. It is self-evident that the examples stated here are by no means to be understood as exhaustive, and that a multitude of other detectable elements are conceivable. Depending on the type of detectable element, it can be incorporated into the material, or applied directly onto the surface, such as with adhesive. It can also be expedient for the detectable element not to be visible or recognisable to a viewer. If the detectable element has a sufficient mass, the detectable element can also cause a center of mass of the container to be outside the longitudinal axis.

According to an advantageous embodiment, it can be provided for a sealing aid to be applied to the sealing surface of the sealing edge, preferably a residue-free removable sealing aid.

The sealing aid can, for instance, be a heat-sealing lacquer. The sealing aid can thereby be applied partially or completely to the sealing surface. This provides the advantage of simplifying recycling and thus enabling comparatively low-cost and energy-efficient reuse. It is thereby conceivable that a further sealing aid is applied to the sealing edge after residue-free removal of the sealing aid. It is conceivable that the sealing aid is designed such that it joins to a sealing foil, such that it is removed from the sealing edge together with the sealing foil when the latter is peeled off, such that no or only little residue of the sealing aid remains on the sealing edge. It is also conceivable that the sealing aid is designed such that it can be removed in a washing process, with or without the use of sealing aid solving chemicals or excipients.

In particular, it can be advantageous for the open end to have a thread, in particular an outer thread, said thread being engageable with another thread, in particular with an inner thread, or a sealing element configured as a screw top. It is of course also conceivable for the open end to be configured with an inner thread which is engageable with a screw top comprising a complementary outer thread. As an alternative or in addition to a thread, the open end can be configured with a bayonet closing mechanism.

This provides the advantage that if an additional sealing element is provided for, a sealing foil can be configured comparatively thinly, or rather with comparatively low puncture resistance and low lateral pressure stability. Furthermore, any sealing aid applied to the sealing surface can have comparatively low adhesion and thus be removed with particularly little residue. In particular, an additional screw top can also enable reclosability for a user, which can also offer good leak protection if the container is transported lying down. Furthermore, a screw top can, as is known in the art, be configured with a ring, said ring detaching from the screw top lid upon first opening, thus serving as proof of originality for the user.

Moreover, it can be provided for the open end to have a press lip, said press lip being engageable with a sealing element configured as a press-on lid. Advantageously, the press lip and press-on lid are complementary in shape, such that a substantially interlocking connection is achieved.

This provides the advantage that if an additional sealing element is provided for, a sealing foil can be configured comparatively thinly, or rather with comparatively low puncture resistance and low lateral pressure stability. Furthermore, any sealing aid applied to the sealing surface can have comparatively low adhesion and thus be removed with particularly little residue. In particular, an additional press-on lid or screw top can also enable reclosability for a user, which can also offer good leak protection if the container is transported lying down. As is known in the art, a press-on lid can be configured with an opening, a tab or an undercut, where said opening, tab or undercut can be depressed or broken off before first opening, thus serving as proof of originality for the user. In order to enable reusability of the container, it can be expedient here for such an opening to be provided for on the lid and not on the sealing edge of the container.

In very general terms, the container can be configured with a proof of originality means, in particular if a further sealing element is provided for in addition to the sealing element. This can, as already described, be a ring which is connected to the sealing element via predetermined breaking points or weaknesses. It is also conceivable that a ring is configured as a ring-pull or tear-off strip, which in addition to a proof of originality can also perform an additional tightening or sealing function. In particular, this can have a positive influence on the shelf life of a product contained in the container.

Furthermore, it can also be provided for the sealing edge to be configured in such a way that the sealing edge can be engaged with snap-in elements of a sealing element configured as a reusable plastic lid.

This provides the advantage of the shelf-life of a product contained in the container, such as a dairy product or bulk product, being improved or extended. That thereby reduces wastage and thus improves sustainability.

An embodiment according to which it can be provided for the reusable plastic container to be configured as a combination packaging container and to comprise an outer component, said outer component being wrapped around the reusable plastic container, wherein the outer component is made of a pre-cut part, said pre-cut part having a substantially circular ring segment basic shape and a first end portion and a second end portion, wherein the pre-cut part is wrapped to form a jacket where the first end portion and the second end portion are joined with one another in an overlap section, wherein the pre-cut part further has a first end face and a second end face and the first end face and the second end face are spaced apart from one another, wherein the outer component has a longitudinal extension extending from the first end face to the second end face, is also advantageous.

According to a further embodiment, it is possible for the jacket of the outer component to have a receiving area and an area, said area being arranged between the receiving area and the second end face when viewed in the longitudinal extension, and for an area of the open end to be received in the receiving area of the jacket of the outer component. The area which is received in the receiving area of the jacket can be a sealing edge or part of the sealing edge.

This provides the advantage that, due to the receiving area and the area arranged between the receiving area and the second front side when viewed in longitudinal extension, it can be ensured that the pre-cut part and the cup-shaped container around which the pre-cut part is wrapped have to be separated from one another to enable access to a product contained within the container. Improved separation and improved recycling can thereby be ensured. Furthermore, the pre-cut part can form a high-quality and attractive outer packaging of a container, wherein the pre-cut part can also fulfil a function as proof of originality and thus serves as “tamper evident”.

As an alternative or in addition, it is also possible for the container to be wrapped by an outer component, as is already known from WO 2020/245148 A1 from the same applicant, for instance.

Outer components of the types described can serve to improve the stability of the container, protect the content from light entry and thermal exposure, and thus improve the shelf life of a product contained in the container. Furthermore, optically attractive designs and any necessary product labelling can be simply and reliably applied. By using outer components which wrap the containers, the containers themselves can be manufactured neutrally, that is to say without product labelling, and can therefore be reused in a particularly flexible manner in a recycling process. For example, various filling plants or various dairies can thus use the same container and apply individual packaging designs.

According to an advantageous further embodiment, it can be provided for the container to have an orientation means in the base area, in particular a groove or an elevation which is configured to fix and/or position the container. The orientation means configured in the base, in particular on the underside of the base, can be configured as an elevation or recess. The container base can be fixed and aligned by engaging a coupling means of an apparatus to attach the outer component on the container with this orientation means in the container base. This can simplify the attachment of the outer component both in the case of wrapping and in the case of axial sliding. The orientation means can be configured as a dovetail in the container base, for example. A tool or coupling means of an apparatus can engage with the orientation means, for instance by interlocking, expansion, or vacuum. Furthermore, an orientation means can serve to ensure exact positioning or alignment of the container during collection, sorting, cleaning, refilling etc.

As is known and common in the art, the sealing edge can be circular and when viewing the container in axial direction can extend constantly outwardly over the jacket. It is, however, also possible for the open end to have a sealing edge which partially protrudes beyond the container jacket. That can mean, for instance, that the sealing edge is configured with protrusions or lips that extend across the container jacket in a radial direction to the conical axis, i.e. at 90° to the conical axis when viewing the container. These protrusions or lips can be received in a receiving area of the jacket of an outer component as part of the sealing edge. Such a sealing edge that partially protrudes over the container jacket can, for example, also be configured as an elliptical sealing edge which extends in a radial direction to the conical axis, i.e. 90° to the conical axis when viewing the container, for instance at two opposing positions across the container jacket. Such an elliptical sealing edge can be received in a receiving area of the jacket of an outer component.

According to the invention, a method for reprocessing a cup-shaped reusable plastic container is also provided. The method comprises the following method steps:
provision of a cup-shaped container, said reusable plastic container comprising a container jacket, said container jacket having an open end and a closed end with a base, wherein a longitudinal axis of the reusable plastic container extends between the open end and the closed end, and wherein the open end has a sealing edge with a sealing surface, from which sealing surface a first sealing foil is removed,
first cleaning of the reusable plastic container to remove content residues,
processing of the sealing surface of the sealing edge to restore the connectability of the sealing surface of the sealing edge with a sealing foil,
refilling of the reusable plastic container with a product,
reconnection of the sealing surface of the sealing edge with a further sealing foil.

The term content residues refers to any residues that can be present in or on the container. This comprises residues of the originally contained product, such as dairy products or any other foodstuff residues, as well as any soilings which can arise when collecting or transporting empty containers, for example.

In particular, the described process is to be understood such that the method steps are performed in an industrial cleaning and recycling process, i.e. in a suitable facility. It is of course conceivable that potential pre-cleaning prior to the described cleaning can take place, such as a user at home manually rinsing or washing out a container prior to returning the empty container. This washing out can also cause content residues, more specifically detergent residues.

It is thereby conceivable that the first cleaning and the processing of the sealing surface are performed in a joint or simultaneous step. In particular, it is conceivable that a connectability or resealability of the sealing surface of the sealing edge is already performed during first cleaning. This may be the case, for example, if a sealing aid on the sealing surface can be removed without residue by a washing process.

The product which is introduced into the container during refilling can be either the original product type or a different product.

Preferably, the method, and in particular the step of reconnecting the sealing surface with a new sealing foil, can be repeated several times, such that the service life of the container and thus its sustainability can be further increased. The method and the construction of the container enable multiple reuse without or at least with no significant loss of quality.

The reconnection of the sealing surface with a further, i.e. a new sealing foil can also be performed with a different sealing method, like the initial sealing with the first sealing foil. It is, for example, conceivable that sealing with the first sealing foil is performed using heat sealing, and that sealing with the respective further sealing foils is performed using cold sealing, or vice versa. As is known in the art, in cold sealing adhesive layers can be provided for on the sealing foil or where necessary also on the sealing edge.

The method according to the invention provides the surprising advantage that reprocessing and thus reuse of a reusable plastic container is possible in a simple manner.

Furthermore, after the processing of the sealing surface of the sealing edge and prior to refilling of the reusable plastic container it can be provided for a second cleaning of the reusable plastic container to be performed to remove processing residues.

This provides the advantage that a resealability of the container can be improved. Furthermore, any processing residues, such as detergent residues or microplastic accrued from abrasive processing can be prevented from coming into contact with and contaminating the product. The second cleaning can thereby comprise the same cleaning methods and process steps as the first cleaning. It is, however, also conceivable that other method steps are expedient for the second cleaning. For instance, the first cleaning can substantially comprise a washing process, and the second cleaning a thermal or pneumatic or chemical process. In particular if processing of the sealing surface is performed using mechanical processing such as grinding or other abrasive methods, a second cleaning using compressed air can be advantageous.

Furthermore, it can be provided for a sealing aid to be applied to the sealing surface of the sealing edge prior to connection of the further sealing foil with the sealing surface of the sealing edge.

This provides the advantage that a particularly good reconnectability or resealability can be achieved. Heat-sealing lacquers can be applied during heat sealing, and adhesives can be applied during cold sealing. It is, however, also conceivable for sealing aids to be provided on the sealing foil instead of the sealing edge.

According to a particular embodiment, it is possible that a mechanical, chemical and/or thermal cleaning step is performed during the first and/or second cleaning. As an alternative or in addition, it is also conceivable that a mechanical, chemical and/or thermal processing step is performed when processing the sealing surface of the sealing edge to restore the connectability.

This provides the advantage that a used container can reliably be returned to its original or new condition, or largely to its original or new condition, thus facilitating reuse.

According to a preferred further embodiment, it can be provided for a plasma treatment to be performed during the first and/or second cleaning of the sealing surface of the sealing edge.

This provides the advantage that a used container can reliably be returned to its original or new condition, or largely to its original or new condition, thus facilitating reuse.

It is also possible that a laser treatment or energetic treatment, such as radiation, for example with ionised radiation, is performed during the first and/or second cleaning.

In particular, it can be advantageous if the sealing surface of the sealing edge is reconnected with the further sealing foil using ultrasonic welding.

It is of course also conceivable for the first, i.e. original sealing foil to also be applied to the sealing surface using ultrasonic welding. This provides the advantage that the container can be reliably sealed.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a reusable plastic container in three-dimensional representation;

FIG. 2 shows a reusable plastic container with indentations in three-dimensional representation;

FIG. 3 shows a further reusable plastic container with indentations in three-dimensional representation;

FIG. 4 shows the reusable plastic container from FIG. 1 in sectional view;

FIG. 5 shows a combination packaging container in three-dimensional representation;

FIG. 6 shows a reusable plastic container with thread in three-dimensional representation;

FIG. 7 shows a reusable plastic container with reusable plastic lid in three-dimensional representation;

FIG. 8 shows a reusable plastic container with an elliptical sealing edge in three-dimensional representation;

FIG. 9 shows an example embodiment of a container base in sectional view; and

FIG. 10 shows a further example embodiment of a container base viewed from below.

### DETAILED DESCRIPTION OF PREFERRED EMBODIMENTS

It is worth noting here that the same parts have been given the same reference numerals or same component configurations in the embodiments described differently, yet the disclosures contained throughout the entire description can be applied analogously to the same parts with the same reference numerals or the same component configurations. The indications of position selected in the description, such as above, below, on the side etc. refer to the figure directly described and shown, and these indications of position can be applied in the same way to the new position should the position change.

The term “in particular” is understood hereinafter as denoting a possible special embodiment or more exact specification of an object or method step, but not necessarily an essential, preferred embodiment of the same or an essential procedure.

In their use herein, the terms “comprising”, “refers to”, “having”, “includes”, “including”, “contains”, “containing” and any variations thereof cover a non-exclusive inclusion.

The term “selectively” may also be used. This is understood such that the method step or system component is fundamentally present, but that it can be used depending on the conditions of use, but use thereof is not essential.

The figures are largely described jointly hereinafter to avoid unnecessary repetitions. Special features and differences between the figures and example embodiments are described in more detail.

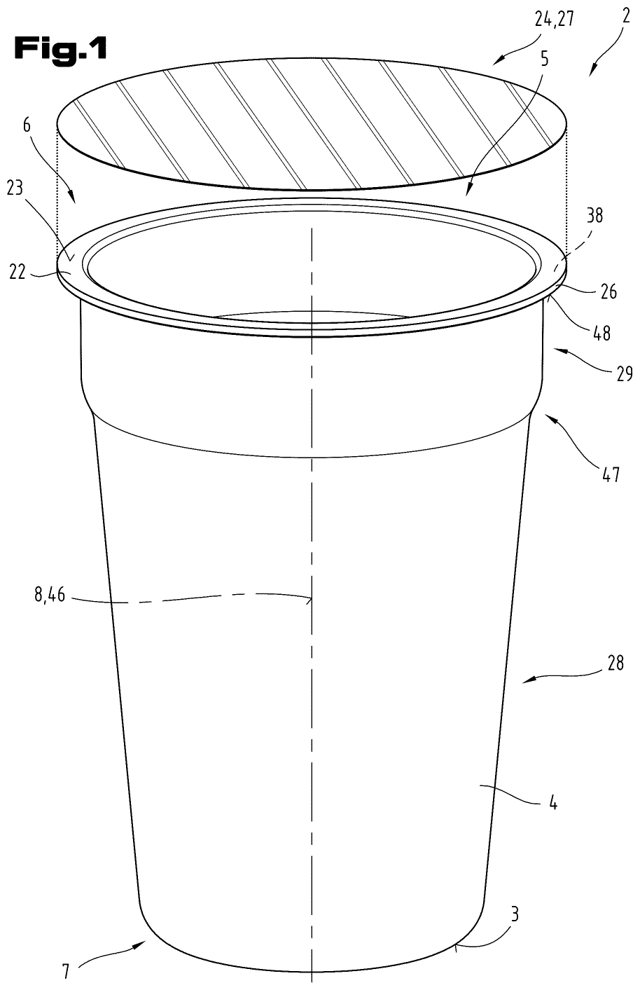

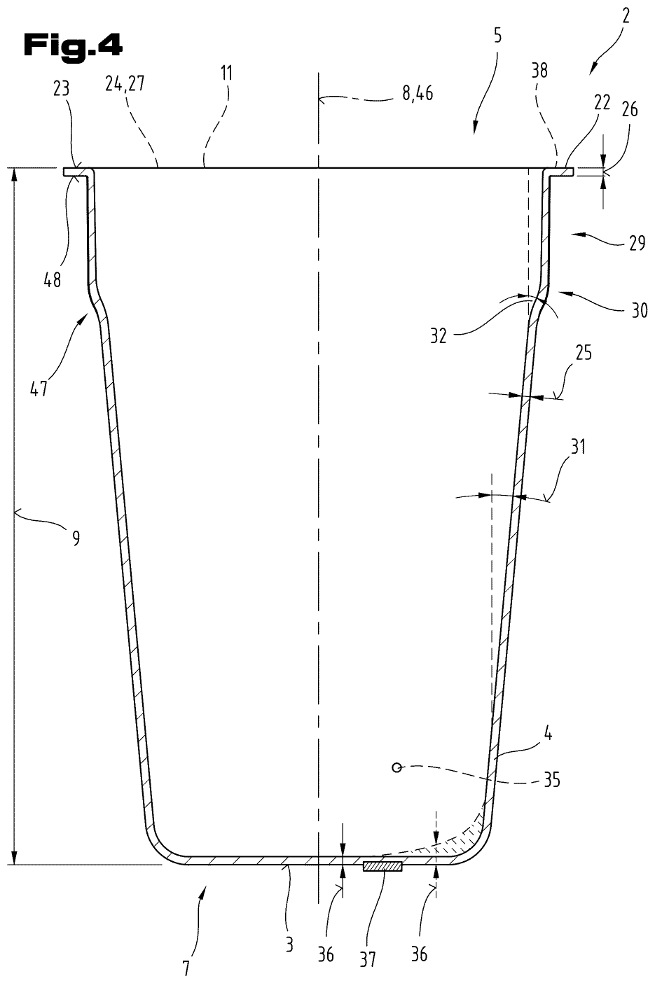

FIG. 1 shows an example embodiment of a reusable plastic container 2 which is exemplary of a plurality of possible different shapes, wherein the reusable plastic containers 2 have a cup or bowl shape such that they can receive a product. The reusable plastic container 2 shown in FIG. 1 is shown again in FIG. 4, however in a sectional view through the longitudinal axis 8, i.e. an axial section. The reusable plastic container 2 comprises a food-safe plastic material. The reusable plastic container 2 preferably comprises a recycled food-safe plastic material. The reusable plastic container 2 comprises a base 3 and a container jacket 4. The container 2 further has an open end 5 on the side opposite the base 3. Furthermore, a flange 6 protruding outwardly over the container jacket 4 can be provided for in the open end 5 area. The base 3 forms a closed end 7 for the container jacket 4. The container 2 has a substantially conical or truncated cone basic shape. The open end 5 has a sealing edge 22 with a sealing surface 23, said sealing surface 23 being configured such that the sealing surface 23 is connectable with a first sealing foil 24. The flange 6 can thereby be configured as a sealing flange. The sealing foil 24, 27 is shown in FIG. 1 prior to connection with the sealing surface 23, i.e. in an exploded view. In FIG. 4, the sealing foil 24, 27 is connected or rather sealed with the sealing surface 23 and completely covers the open end 5 such that the reusable plastic container 2 is closed. As is known in the art, sealing foils 24 can have a tab or protrusion which facilitates the user peeling the sealing foil 24, 27 from the sealing edge 22. For the sake of simplicity, such a tab is not depicted.

The container 2 is preferably formed by a component produced in a thermoforming process which can be manufactured in a swift and above all short cycle. The thermoforming process is well known in the art and is therefore not explained in more detail. Thermoforming is particularly suited to taking a layer of mouldable material and using a thermoforming tool to manufacture the container 2 with a sufficient wall thickness which ensures impermeability during storage and use until disposal. The container 2 can, however, also be shaped using other production methods, such as injection moulding.

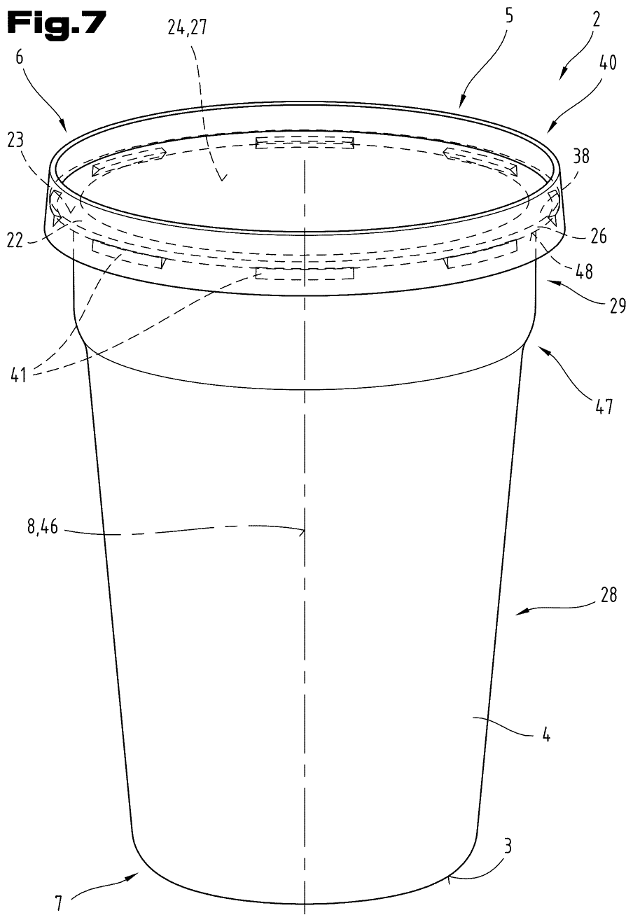

Due to the cup or bowl shape of the container 2, a longitudinal axis 8 extends in an axial direction between the open end 5 and the closed end 7 with the base 3, where the longitudinal axis can also form a center axis if the container is symmetrical. In addition to a sealing foil 24, 27, it is possible to arrange or connect therewith a further sealing element 11, for example a screw-top, a press-on lid, or a reusable plastic lid 40 (as shown as an example in FIG. 7) in the area of the flange 6 or in the area of the sealing edge 22.

In an axial direction and thus in the direction of the longitudinal axis 8, the container 2 has a container height 9 between its open end 5, in particular the flange 6 or the sealing edge 22, and the base 3 according to which the capacity of the container 2 is determined depending on the cross-sectional dimensions. The container height 9 in conjunction with the cross-sectional dimensions thereby defines the receiving area of the container 2.

The container jacket 4 is understood as the section of the container 2 which extends between the open end 5, in particular the flange 6, and the base 3 in a predominantly axial direction. The container 2 with its container jacket 4 is preferably configured in such a way that it tapers in a preferably conical way from the open end 5 to the base 3, and thus has a predominantly truncated cone shape. In this configuration, the longitudinal axis 8 corresponds to the conical axis 46.

The sectional view in FIG. 4 in particular clearly shows that the container jacket 4 has a wall thickness 25, said wall thickness 25 being from 0.5 mm to 4.0 mm. Furthermore, the sealing edge 22 has a sealing edge thickness 26, said sealing edge thickness 26 extending in the axial direction of the longitudinal axis 8, and said sealing edge thickness 26 being from 0.8 mm and 4.0 mm. The sealing surface 23 is thereby configured such that the sealing surface 23 can be connected to a further sealing foil 27 after removal of the first sealing foil 24 of the sealing surface 23 of the sealing edge 22, and following cleaning of the reusable plastic container 2. FIGS. 1 and 4 further show that the container jacket 4 can have a conical section 28. This conical section 28 extends from the closed end 7 towards the open end 5. Furthermore, it is shown that the container jacket 4 can have a cylindrical section 29, said cylindrical section 29 extending from the open end 5 towards the closed end 7. When viewing the reusable plastic container 2 in radial direction to the longitudinal axis 8, i.e. at 90° to the longitudinal axis 8, a circular cross section of the cylindrical section 29 is larger than a maximum circular cross section of a conical section 28. The cylindrical section 29 thus constitutes an annular, cylindrical broadening which joins up with the conical section 28.

Furthermore, FIGS. 1 and 4 show that when viewed in axial direction a conical transition section 30 can be configured between the conical section 28 and the cylindrical section 29, wherein a first angle 31 between the longitudinal axis 8 and the conical section 28 is smaller than a second angle 32 between the longitudinal axis 8 and the conical transition section 30. That thereby enables a broadening of the diameter or circular cross section from the conical section 28 towards the cylindrical section 29. The transition section 30 practically forms a shoulder or limit area 47 encircling the jacket, which, if two or more reusable plastic containers 2 of the same configuration are stacked on top of one another or inserted into one another in an axial direction, serves as a limit for a flange 6 or for a lower section or underside 48 of the sealing edge 22. The term underside 48 of the sealing edge 22 refers to the side or surface of the sealing edge 22 that faces the base 3.

In the axial cross section through a reusable plastic container 2 shown in FIG. 4, there is an additional layer shown which can assume the center of mass 35 of the reusable plastic container 2. Specifically, it is hereby shown that the center of mass 35 of the reusable plastic container 2 can be outside the longitudinal axis 8, i.e. not directly on the longitudinal axis 8. When viewed along its container height 9, the center of mass 35 can be in a half of the container height 9 facing the closed end 7 or in a third of the container height 9facing the closed end 7. In the example shown, the center of mass 35 is also closer to the container jacket 4 than to the longitudinal axis 8, that is to say further away from the longitudinal axis 8 than from the container jacket 4.

A dashed line denotes a conceivable configuration of the base 3 and of the container jacket 4 in the transition section to the base 3, wherein the base thickness 36 increases when viewed radially outwards. The base 3 is circular or has a round circular cross section. When viewed along its diameter, the base 3 has different base thicknesses 36, said base thickness 36 being between 0.5 mm and 4.0 mm. It is also possible for the wall thickness 25 of the container jacket 4 to vary. In the example shown in FIG. 4, the base thickness 36 increases radially from the center of the base towards the periphery. Furthermore, the wall thickness 25 of the container jacket 4 is larger or increases in the transition section to the base 3. A detectable element 37, for example an RFID chip or an NFC chip, is applied to or incorporated into the base 3.

To facilitate connectability with a sealing foil 24, 27, a sealing aid 38 which can preferably be removed without residue can be applied to the sealing surface 23 of the sealing edge 22. For example, a sealing aid 38 can be a heat-sealing lacquer or an adhesive. It is, however, also conceivable for the sealing aid 38 to be applied to the sealing foil 24, 27 and for the sealing aid 38 to first come into contact with the sealing surface 23 of the sealing edge 22 when the sealing foil 24, 27 is sealed.

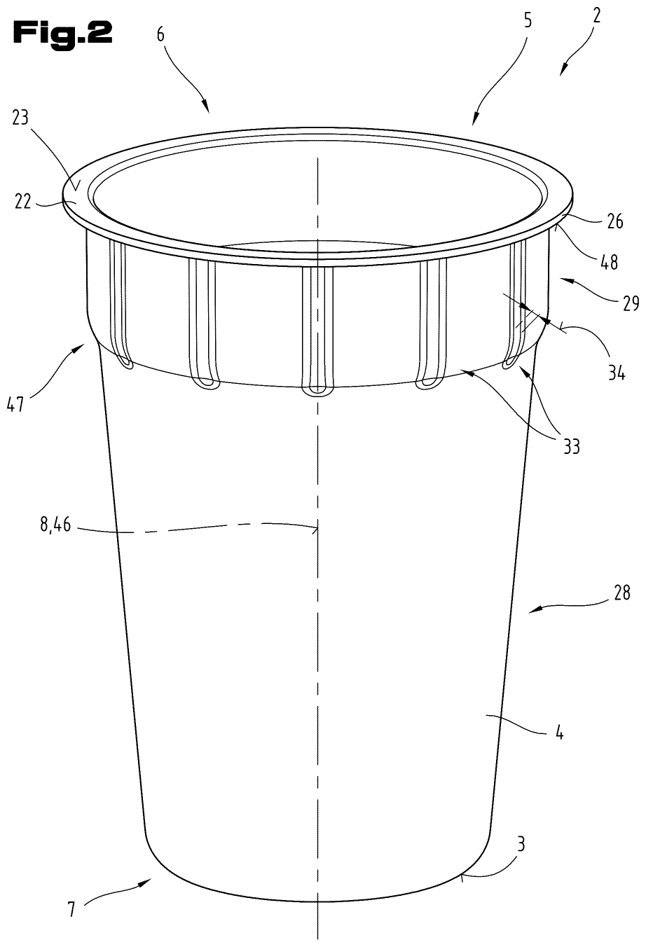

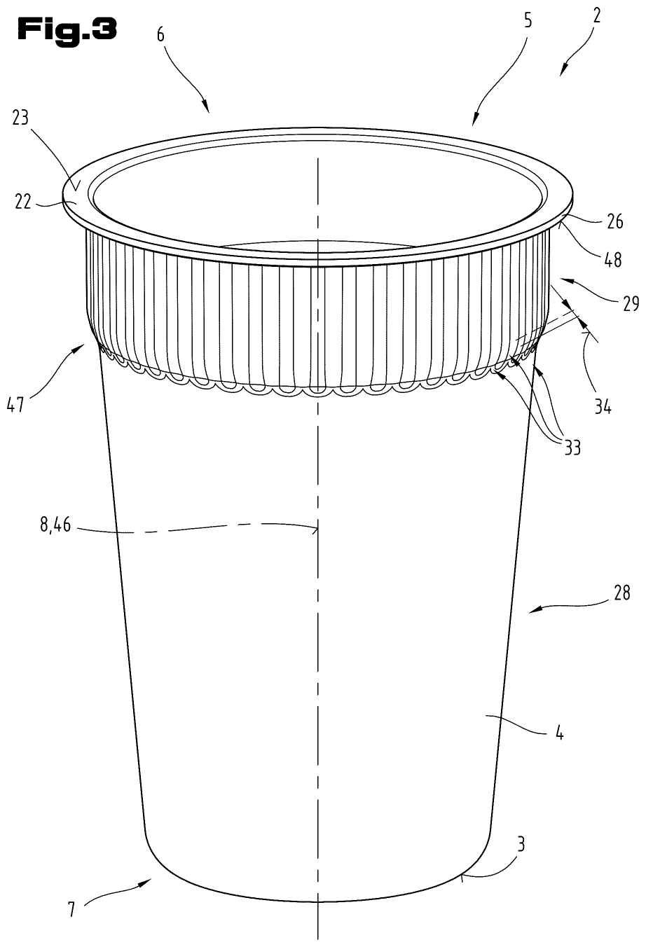

FIGS. 2 and 3 show two further example embodiments of cup-shaped reusable plastic containers 2, however each without the sealing foil 24, 27, that is to say in the opened or unsealed state. Reference is made here substantially to the description passages in conjunction with FIG. 1 and FIG. 4. In addition to the features already described, the reusable plastic containers 2 in FIGS. 2 and 3 have indentations 33 in the container jacket 4, said indentations 33 extending substantially parallel to the longitudinal axis 8 across the cylindrical section 29. The indentations 33 have a depth 34 in a radial direction to the longitudinal axis 8, i.e. 90° to the longitudinal axis 8, where said depth 34 can be from 1% to 70% of the wall thickness 25 of the container jacket 4.

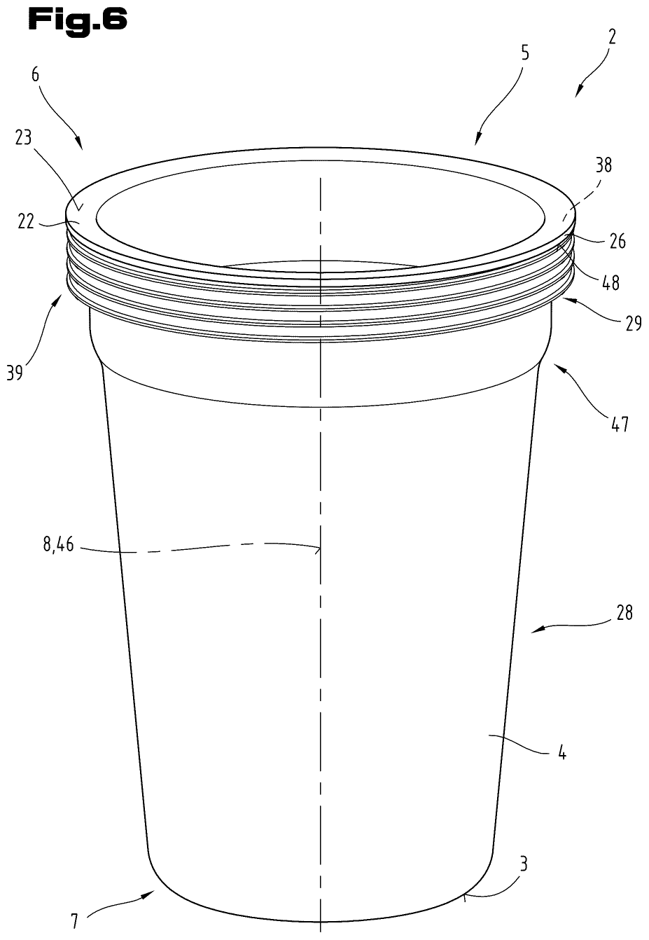

FIG. 6 shows a further example embodiment of a cup-shaped reusable plastic container 2. Reference is substantially made to the aforementioned passages of the description. In addition to sealability using a sealing foil 24, 27, it is provided for here that the reusable plastic container 2 can be sealable using a further sealing element, not shown in more detail. To do so, the open end 5 can have a thread 39, in particular an outer thread, said thread 39 being engageable with another thread, in particular with an inner thread of a sealing element configured as a screw top. The thread shown in FIG. 2 39 is to be understood only as an example, with the exact configuration of the thread 39 being at the discretion of the skilled person. Expediently, the thread 39 is however configured with sufficient stability that multiple use, multiple cleaning, and multiple refilling of the reusable plastic container 2 is possible without risking premature final disposal due to a damaged thread 39.

Alternatively, and not shown in the figures, it is also conceivable for the open end 5 to have a press lip, said press lip being engageable with a sealing element configured as a press-on lid.

FIG. 7 shows a variation or further embodiment of the cup-shaped reusable plastic container 2 according to FIGS. 1 and 4, wherein here the sealing edge 22 is configured such that the sealing edge 22 can be engaged with snap-in elements 41 of a sealing element configured as a reusable plastic lid 40. It is thereby conceivable that the plastic container 2 is sealed with the sealing foil 24, 27 as shown, and that the reusable plastic lid 40 is applied in addition. It is, however, also conceivable for the plastic container 2 to already have been opened, or rather for the sealing foil 24, 27 to already have been peeled off, and for the reusable plastic lid 40 to thus seal the container without the sealing foil 24, 27.

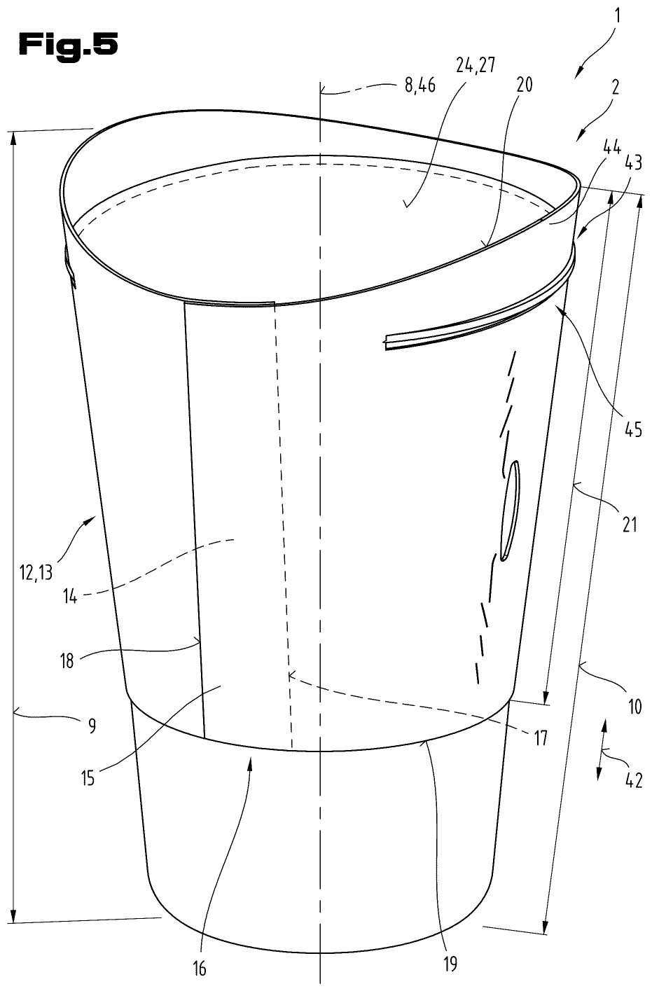

FIG. 5 shows a variation or further embodiment of a cup-shaped reusable plastic container 2 in which the reusable plastic container 2 is configured as a combination packaging container 1. The reusable plastic container 2 thereby comprises an outer component 12, where said outer component 12 is wrapped around the reusable plastic container 2, wherein the outer component is formed by a mostly flat pre-cut part 13, said pre-cut part 13 having a substantially circular ring segment basic shape, said pre-cut part 13 having a first end portion 14 and a second end portion 15, wherein the pre-cut part 13 is wrapped to form a jacket and whereby the first end portion 14 and the second end portion 15 are joined with one another in an overlap area 16, wherein the outer component 12 further has a first end face 19 and a second end face 20 and the first end face 19 and the second end face 20 are spaced apart from one another, wherein the outer component 12 has a longitudinal extension 42 extending from the first end face 19 to the second end face 20.

When viewing the combination packaging container 1 in the three-dimensional view as shown, the combination packaging container 1 has a total height 10 extending from the base 3 up to the uppermost area of the second end face 20 of the outer component 12. The total height can thus be greater than the container height 9 and also greater than the construction height 21 of the outer component 12.

FIG. 5 also shows that the jacket of the outer component 12 has a receiving area 43 and an area 44, said area 44 being arranged between the receiving area 43 and the second end face 20 when viewed in the longitudinal extension 42, and that an area 45 of the open end 5 is received in the receiving area 43 of the jacket of the outer component 12.

The cuff-shaped outer component 12 is preferably made from a cellulose material such as card, with sufficient rigidity with respect to the absorption and transfer of axial pressures in particular, and is wrapped to form a jacket from a flat pre-cut part 13. The pre-cut part 13 is usually printed in its non-shaped, flat state and, where necessary, an additional coating is applied. In particular, it is of course possible for the pre-cut part 13 to be composed of several components. A cellulose material is usually used for the pre-cut part 13, wherein this can also be recycled card or kraft paper. Where a layer or ply of the outer component 12 is made from recycled material, an additional layer of high-quality paper can be arranged or bonded to at least one of the surfaces. This additional layer enables flawless printing of decorative elements, text, or product information.

The cuff-like or jacket-like outer component 12 provides an additional reinforcement or stiffening effect for the container 2 and thus for the entire combination packaging container 1. On the one hand, this provides high rigidity and good thermal insulation, and on the other hand optimum light protection for the contents of the packaging container.

In particular, it can be provided for the card in the area of the cut edges to be additionally coated or sealed with a water-repellent material. This is particularly advantageous if the combination packaging container 1 is exposed to increased moisture influx. Coating the card used for the outer component 12 with a water-repellent layer prevents swelling of the card in moist environments, which would ultimately cause the container jacket 4 to detach from the combination packaging container 1.

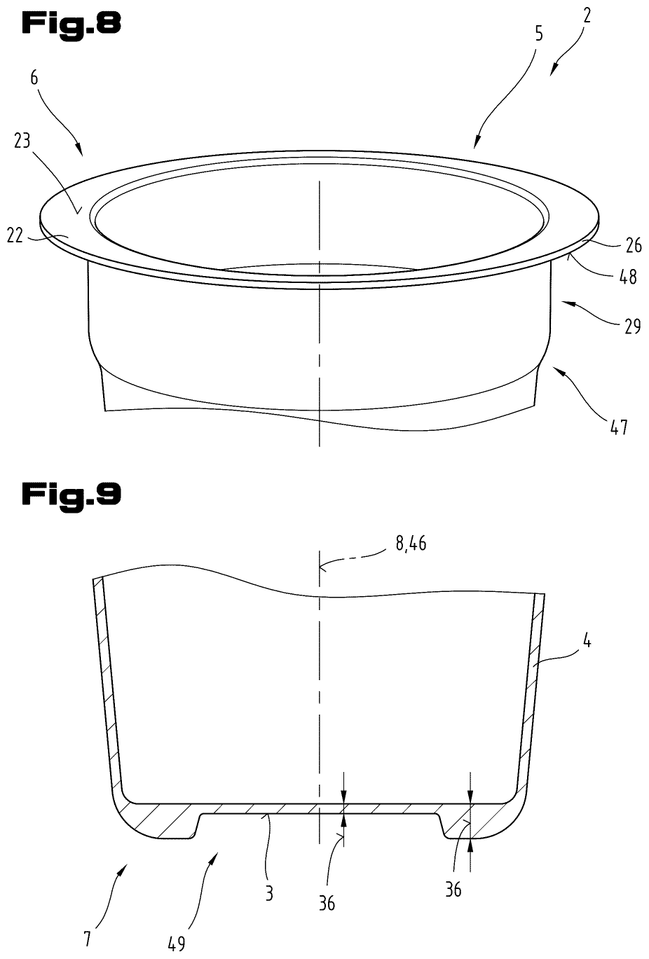

FIG. 8 shows a reusable plastic container 2 with an elliptically configured sealing edge 22. Alternatively to the circular shaped sealing edge 22 shown in FIG. 1, it is possible for the open end 5 to have a sealing edge 22 partially protruding over the container jacket 4 of the container 2. Such a sealing edge 22 that partially protrudes over the container jacket 4 of the container 2 can be configured as an elliptical sealing edge 22 which extends in a radial direction to the conical axis 46, i.e. 90° to the conical axis 46 when, for instance, viewing the container at two opposing positions across the container jacket. This is in particular the case if the reusable plastic container 2 is combined with an outer component 12 to form a combination packaging container 1.

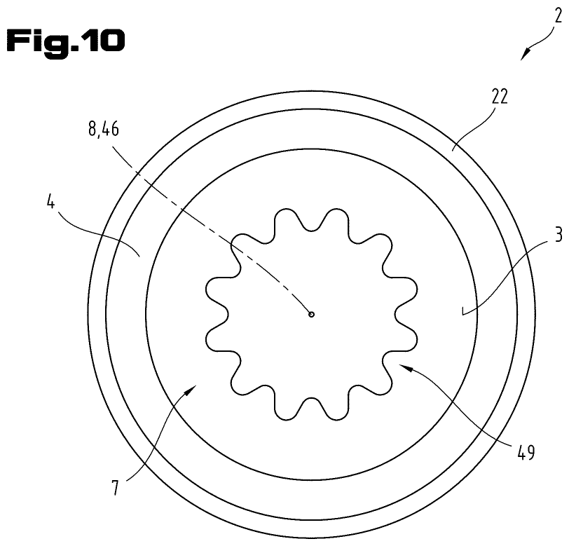

It is also possible for the container (2) to have an orientation means (49) in the base (3) area, in particular a groove or—not shown—an elevation which is configured to fix and/or position the container 2. Such a variation is shown by FIGS. 9 and 10 as an example and represents a multitude of possible embodiments. The orientation means 49 configured in the base 3, in particular on the underside of the base 3, can be configured as a protrusion or recess, as shown. The container base can be fixed and aligned by engaging a coupling means, not shown in more detail, of an apparatus to attach the outer component on the container 2 with this orientation means 49 in the container base 3. This can simplify the attachment of the outer component 12 both in the case of wrapping and in the case of axial sliding. The orientation means 49 can be configured as a dovetail in the container base 3, for example. This is represented in particular in FIG. 10. A star-shaped orientation means 49 or an orientation means 49 with a cog-like contour in the base 3 is hereby provided. A tool or coupling means of an apparatus can engage with the orientation means 49, for instance by interlocking, expansion, or vacuum. The required configuration, along with a height of an elevation or a depth of a groove or dovetail can thereby be adjusted to the respective tool or coupling means of an apparatus. In particular because the base 3 is comparatively thick, such an orientation means 49 can be well integrated into the base 3.

The reusable plastic containers 2 shown in the figures can be processed in a reprocessing method such that repeat or multiple use is enabled. The method provides for a used container 2 to be provided, wherein a first sealing foil 24 has already been removed from the sealing surface 23 of the sealing edge 22. The removed sealing foil can also be an already removed further sealing foil 27. This is in particular the case if the reusable plastic container 2 has already been treated several times in the reprocessing method. Subsequently, the reusable plastic container 2 is subjected to a first cleaning step, wherein any product residues are removed. This is done using a wash process, for example, where necessary using detergent. At the same time as the first cleaning, during the first cleaning or after the first cleaning, the sealing surface 23 of the sealing edge 22 is processed such that it is suitable for restoring the connectability of the sealing surface 23 of the sealing edge 22 with a sealing foil 24, 27. In particular, an original condition of the sealing surface 23 is at least substantially restored by processing. The reusable plastic container 2 is subsequently refilled with a product. It can thereby be the same as the original or previously contained product, but also a different product. A closing or sealing of the reusable plastic container 2 is performed after refilling by reconnecting the sealing surface 23 of the sealing edge 22 with a further sealing foil 27.

A method step can also be provided after the processing of the sealing surface 23 of the sealing edge 22 and prior to refilling of the reusable plastic container 2 according to which a second cleaning of the reusable plastic container 2 to remove processing residues is performed. Such processing residues can include detergent residues or grinding residues, for example. Where necessary, a sealing aid 38 can be applied to the sealing surface 23 of the sealing edge 22 prior to connecting the further sealing foil 27 with the sealing surface 23 of the sealing edge 22. A mechanical, chemical and/or thermal cleaning step can be performed during the first and/or second cleaning of the sealing surface 23 of the sealing edge 22. A plasma treatment can be performed during the first and/or second cleaning of the sealing surface 23 of the sealing edge 22. Furthermore, it is possible that the sealing surface 23 of the sealing edge 22 is reconnected with the further sealing foil 27 using ultrasonic welding.

The example embodiments show possible embodiment variations, whereby it is noted that the invention is not limited to the specific embodiment variations represented herein, rather various combinations of the individual embodiment variations with one another are possible and this variation possibility is within the abilities of the skilled person in this technical field given the technical teachings provided by this invention.

The scope of protection is defined by the claims. The description and the drawings should, however, be consulted when interpreting the claims. Individual features or combinations of features from the various example embodiments shown and described herein can each represent individual solutions according to the invention. The respective underlying problem to be solved by the individual solutions according to the invention can be derived from the description.

All value ranges specified in the current description are to be understood such that they include any and all sub-ranges, e.g., the specification 1 to 10 is to be understood such that all sub-ranges, starting from the lower limit 1 and the upper limit 10 are included, i.e., all sub-ranges begin with a lower limit of 1 or more and end at an upper limit of 10 or less, e.g., 1 to 1.7, or 3.2 to 8.1, or 5.5 to 10.

As a matter of form and by way of conclusion, it is noted that, to improve understanding of the structure, elements have partially not been shown to scale and/or enlarged and/or shrunk.

Although only a few embodiments of the present invention have been shown and described, it is to be understood that many changes and modifications may be made thereunto without departing from the spirit and scope of the invention.

### LIST OF REFERENCE NUMERALS

1 Combination packaging container
2 Reusable plastic container
3 Base
4 Container jacket
5 Open end
6 Flange
7 Closed end
8 Longitudinal axis
9 Container height
10 Total height
11 Sealing element
12 Outer component
13 Pre-cut part
14 First end portion
15 Second end portion
16 Overlap area
17 First longitudinal edge
18 Second longitudinal edge
19 First end face
20 Second end face
21 Construction height
22 Sealing edge
23 Sealing surface
24 First sealing foil
25 Wall thickness
26 Sealing edge thickness
27 Further sealing foil
28 Conical section
29 Cylindrical section
30 Transition section
31 First angle
32 Second angle
33 Indentation
34 Depth
35 Center of mass
36 Base thickness
37 Detectable element
38 Sealing aid
39 Thread
40 Reusable plastic lid
41 Snap-in element
42 Longitudinal extension
43 Receiving area
44 Area
45 Area
46 Conical axis
47 Limit area
48 Underside
49 Orientation means

What is claimed is:

1. A method for reprocessing a cup-shaped reusable plastic container, comprising the following method steps:
providing a cup-shaped reusable plastic container comprising a container jacket having an open end and a closed end with a base, wherein a longitudinal axis of the cup-shaped reusable plastic container extends between the open end and the closed end, wherein the open end has a sealing edge with a sealing surface connected to a first sealing foil, wherein the container jacket has a wall thickness of 0.5 mm to 4.0 mm, wherein the sealing edge has a sealing edge thickness extending in an axial direction of the longitudinal axis, wherein the sealing edge thickness is from 0.8 mm to 4.0 mm;
removing the first sealing foil from the sealing surface;
performing a first cleaning of the cup-shaped reusable plastic container to remove content residues;
processing the sealing surface of the sealing edge to restore a connectability of the sealing surface of the sealing edge with a sealing foil;
refilling the reusable cup-shaped plastic container with a product; and
reconnecting the sealing surface of the sealing edge to a further sealing foil.

2. The method according to claim 1, wherein after the processing of the sealing surface of the sealing edge and prior to refilling of the cup-shaped reusable plastic container, a second cleaning of the cup-shaped reusable plastic container is performed to remove processing residues.

3. The method according to claim 2, wherein at least one of the first cleaning and the second cleaning comprises at least one of mechanical cleaning and chemical cleaning.

4. The method according to claim 2, wherein at least one of the first cleaning and the second cleaning comprises a plasma treatment.

5. The method according to claim 1, wherein a sealing aid is applied to the sealing surface of the sealing edge prior to connecting the further sealing foil to the sealing surface of the sealing edge.

6. The method according to claim 1, wherein the processing of the sealing surface of the sealing edge comprises a thermal cleaning step.

7. The method according to claim 1, wherein the sealing surface of the sealing edge is reconnected to the further sealing foil using ultrasonic welding.
